(19) United States
(12) Patent Application Publication
(10) Pub. No.: US 2026/0111692 A1
(43) Pub. Date: Apr. 23, 2026

(54) Kamerasystem für eine Etikettenerkennungsvorrichtung

(71) Applicant: SICK AG, Waldkirch (DE)

(72) Inventors: Andreas JÄCKLE, Freiburg (DE); Jannik BURGER, Rheinhausen (DE)

(21) Appl. No.: 19/366,108

(22) Filed: Oct. 22, 2025

(30) Foreign Application Priority Data
Oct. 23, 2024 (EP) 24208248.5
Oct. 20, 2025 (EP) 25209884.3

(51) Int. Cl. G06K 7/14; H04N 23/54; H04N 23/695

(52) U.S. Cl. CPC G06K 7/1404; H04N 23/54; H04N 23/695

(57) ABSTRACT

The invention relates to a camera system for a label recognition apparatus, wherein the camera system is configured to recognize 1D and/or 2D label codes on at least one object that is moved by a conveying apparatus, in particular a conveyor belt. The camera system has a camera unit having a camera lens and an image sensor as well as a processor, wherein the camera unit is configured to record a sequence of images of the object. The processor is configured to process the images and to recognize 1D and/or 2D label codes arranged on the object. The camera system has a pivoting apparatus that is connected, in particular releasably connected, to the camera unit and that is configured to pivot the camera unit in at least one pivot plane from a starting position about a pivot angle.

The invention relates to a camera system for a label recognition apparatus, wherein the camera system is configured to recognize 1D and/or 2D label codes on at least one object that is moved by a conveying apparatus, in particular a conveyor belt, wherein the camera system has a camera unit having a camera lens and an image sensor as well as a processor, wherein the camera unit is configured to record a sequence of images of the object, and wherein the processor is configured to process the images and to recognize 1D and/or 2D label codes arranged on the object.

The application of the identification of 1D and 2D label codes on objects, for example packages or also pallets, that are transported by a conveying apparatus such as a roller conveyor, is of central importance for companies in various industries, in particular in the field of logistics and warehousing. A company that manages an extensive flow of goods needs a reliable method of identifying objects during the transport on a conveying apparatus. The identification takes place by reading label codes on the objects that contain important information about the contents, the origin and the destination of the goods.

Camera-based code readers for the automatic identification of objects on conveying apparatus are therefore an important technology in logistics and in warehouse management. The code readers capture images, in particular high-resolution images, of the objects, analyze them by means of image processing algorithms and recognize precise label codes such as 1D or 2D codes. The extracted data are processed in real time and converted into digital formats that can be used by other systems. This camera-based technology automates the identification process, improves the efficiency of warehouse operations and reduces human error. It is characterized by a robustness, reliability and seamless integration into existing conveying apparatus systems. Overall, camera-based code readers enable an efficient and precise identification of moving objects and contribute to the optimization of logistics processes.

This poses a variety of challenges, such as the diversity of the code types.

The label codes used can be both 1D and 2D codes, including GS1 SSCC barcodes. The identification solution must be able to precisely read and interpret different code types in order to ensure an accurate goods tracking. Furthermore, objects such as pallets can have different heights and widths depending on the region and the area of application. This variability requires a flexible identification solution that is able to accurately capture and read label codes on objects of different heights and widths. Since the label codes on the objects can be arranged on all sides of the objects, the code reading system must be capable of enabling a 360-degree capture. It can thus be ensured that all the label codes are captured precisely, regardless of their arrangement on the object. Furthermore, the objects themselves can also be located in different positions and orientations on the conveying apparatus.

The code reader must be able to accurately identify and read label codes regardless of the position and orientation of the object. Conveying apparatus such as conveyor belts can furthermore be operated at high conveying speeds to enable an efficient transport of the objects. In this respect, the label codes must be able to be captured and processed precisely, even in the case of a fast transport and high conveying speeds. The working environment in which the capture or identification of the label codes takes place also deserves attention. It can vary and can contribute additional challenges such as poor lighting, dust or reflections. The camera-based capture of label codes must therefore be robust enough to work reliably under different environmental conditions. The code reader must furthermore have a sufficiently large field of view to be able to capture all the label codes on an object within an image sequence without additional adjustments of the position of the camera unit being required. Furthermore, the depth of field of the camera unit must also be sufficient to be able to focus on the label codes on the objects sufficiently, and this regardless of their position on the object and their distance from the camera unit.

Current solutions according to the prior art use camera-based reading devices with a controllable high-speed mirror to read and identify label codes on moving objects, such as pallets and large packages, on conveying apparatus such as conveyor belts. Systems comprising such reading devices are able to read label codes using a single reading device, even from short working distances and over a wide field of view. However, the disadvantage of such reading devices is the high acquisition costs that result from additional hardware and the possibly required specialized training. Furthermore, the implementation of such a system can be complex and can require specific expertise, which can take time and resources.

It is therefore an object of the invention to provide an improved camera system for a label recognition apparatus, said camera system being efficient, reliable, low-wear and cost-effective.

The object is satisfied by a camera system having the features of claim 1 and in particular in that the camera system has a pivoting apparatus that is connected, in particular releasably connected, to the camera unit and that is configured to pivot the camera unit in at least one pivot plane from a starting position about a pivot angle.

Due to the pivoting, the object that is moved by or on the conveying apparatus can be captured by the camera unit and its image sensor in the sequence of images at different capture angles, wherein the different capture angles result from the pivoting of the image field of the camera unit by the pivoting apparatus. A recording of images of the object and the capture of the label codes arranged thereon at different capture angles of the camera unit is thus achieved in that the camera unit itself is pivoted as a whole. The recording of images of the object at different capture angles ensures that a label code arranged on the object is captured regardless of its position and orientation on the object and also regardless of the size and orientation of the object in the images. The images of the object are transmitted to the processor that processes them and scans the images for 1D and/or 2D label codes arranged on the object, said processor recognizing and reliably identifying said 1D and/or 2D label codes.

The camera unit forms a code reading device that has the functions that are necessary for recognizing the label codes. The camera unit in particular has its own camera housing in which the camera lens, the image sensor and the processor can be arranged. For an energy supply and/or a data transmission, connection devices to which external power or data connections can be connected can be provided at the outer side of the camera housing. The camera unit can also have an illumination device, for example, in the form of LED lamps that are arranged at the outer side of the camera housing and that enable an illumination of the object.

The pivoting apparatus preferably pivots the camera unit as a whole. The pivoting apparatus in particular pivots the camera housing with the components arranged in its interior and at the outer side, such as the camera lens, the image sensor, the processor and the illumination device. In this respect, the components within the camera housing are also rigidly arranged during the pivoting. The relative position of the camera housing, camera lens, image sensor, processor and illumination device therefore also remains unchanged during the pivoting.

Since the camera unit itself is pivoted, it is not necessary to keep available controllable mirrors in order to recognize label codes regardless of their arrangement and/or orientation. By dispensing with mirrors, which have to be set up and kept in a clean state during the operation, the camera system is easy to install, cost-effective and low-maintenance. Furthermore, due to the dispensing of additional optical elements such as controllable mirrors, the internal illumination, which is usually integrated into the camera unit, is sufficient to obtain sufficiently illuminated images of the object for the recognition of the label codes. It is thus not necessary to provide an additional external illumination.

Due to the pivoting apparatus, a reliable and accurate capture of label codes on the objects is ensured, which improves the efficiency and the accuracy of the recognition and the identification. Due to the pivoting apparatus, it is made possible to optimally align the camera unit in order to ensure a reliable capture of the label codes, even if the objects and/or the label codes are arranged at different angles relative to the camera unit. The objects and the label codes arranged thereon can thereby be efficiently captured regardless of the height and width of the objects.

To capture the label codes on the objects, the camera system can, for example, be positioned next to the conveying apparatus. This can, for example, take place orthogonally to the conveying apparatus or at a 45° angle thereto. The conveying apparatus can, for example, comprise a conveyor belt, a robot arm, a lifting truck or an autonomous guided vehicle (AGV). Camera systems can be arranged at both sides of the conveying apparatus to fully capture the 360° angle. Thus, an object moved on a conveying apparatus can be fully captured regardless of its height or width and every label code arranged on the object can be seen, captured, read and identified by the processor.

The at least one pivot plane can extend in a horizontal direction and/or in a vertical direction relative to the conveying apparatus. If the pivoting apparatus has two pivot planes that extend in a horizontal and a vertical direction, the image field captured by the camera unit can be enlarged both horizontally and vertically. The camera system can thus efficiently capture the object both horizontally and vertically.

The camera system can have an outer housing in which the camera unit and the pivoting apparatus are arranged and accommodated. The outer housing has at least one transparent viewing window that enables the camera unit to record a sequence of images of the object for each orientation between the starting position and the maximum pivot angle.

The outer housing can be fastenable to a construction profile. The construction profile can have a fastening apparatus, for example, a fastening plate that enables the outer housing to be fixed in a vibration-proof manner in a working environment. The outer housing can be rotatably supported at the construction profile to be able to orient and fix the camera system at different angles to the conveying apparatus. This, for example, enables a quick change between a side reading and a 45 degree reading of the moving objects without lengthy conversions or changes to the assembly of the camera system being necessary.

According to one embodiment, a pivot axis associated with the pivot plane is arranged outside the camera unit. The pivot axis extends orthogonally to the pivot plane. The arrangement of the pivot axis outside the camera unit enables a simple and cost-effective design of the pivoting apparatus.

According to one embodiment, the pivoting apparatus has an installation housing, a drive member and a motor, in particular an electric motor, wherein the camera unit is fixed, in particular releasably fixed, to the installation housing, the drive member is connected to the installation housing and the drive member can be driven by the motor to bring about a pivoting of the installation housing and the camera unit. The pivoting of the camera unit is thus brought about via a pivoting of the installation housing, wherein the drive member is in an operative connection with the installation housing. The drive member is thus configured to pivot the installation housing in the pivot plane when driven by the motor. In this respect, the motor enables a precise movement control of the camera unit, which contributes to a uniform and accurate capture of the label codes. The installation housing can be configured such that different camera units can be fixed thereto. This enables an adaptation and/or optimization of the camera system to specific requirements of the application that can easily be carried out. Advantageously, a replacement of the entire camera system is necessary for this purpose. Rather, it can be sufficient to replace one camera unit with another camera unit that, for example, has a higher resolution or whose recording parameters are better suited to the current application.

According to one embodiment, the pivoting apparatus is configured to return the camera unit to the starting position after a pivoting about the pivot angle has taken place. The pivoting apparatus is thus configured to perform an automatic oscillating movement between the starting position and a maximum outwardly pivoted position. For example, the drive member, when driven by the motor, can perform a periodic movement that returns said pivoting apparatus to its starting position after a completed period. The automatic oscillating movement of the pivoting apparatus and of the associated camera unit improves the efficiency of the capture of the label code since it enables a consistently fast and continuous movement of the camera unit over the objects moved on the conveying apparatus.

According to one embodiment, the pivot angle can be predefined or is predefined. The pivot angle of the camera unit and thus the amplitude of the oscillation can be set. The angles of inclination that can be achieved by the camera unit can thereby be set and the movement of the camera unit can be fine-tuned. This enables an adaptation to specific requirements of the application area in order to achieve optimal results of the recognition of the label code by the camera system.

According to one embodiment, the pivoting apparatus is configured to pivot the camera unit in the pivot plane at a predefined or predefinable pivoting speed, in particular wherein the pivoting speed can be adapted to the conveying speed of the conveying apparatus. Alternatively or in addition to the adaptable amplitude, the pivoting speed and thus the frequency of the oscillation can also be adapted in order to achieve the best possible results of the recognition of the label codes: The possibility of adapting the amplitude and/or the frequency of the oscillation enables the user to fine-tune the movement of the camera unit in order to meet the specific requirements of the respective application area and to achieve optimal results. By adapting the pivoting speed to the conveying speed, it can be achieved that, in the images of the sequence of images generated by the camera unit, the object is captured and imaged as comprehensively as possible at different angles of view. This ensures an efficient and reliable capture of the label codes by the processor.

According to one embodiment, a maximum pivot angle is 120 degrees, in particular 150 or 180 degrees. Pivot angles of this magnitude enable the reliable recognition of label codes that are arranged at a variety of angles to the starting position of the camera unit. Camera systems can be arranged on both sides of the conveying apparatus to fully capture the 360° angle. Thus, an object on a conveying apparatus can be fully captured, regardless of the height of said conveying apparatus, and every label code arranged on the object can be seen, read and identified.

According to one embodiment, the pivoting of the camera unit by the pivoting apparatus can be initiated by a start signal, in particular an external start signal. In other words, the pivoting apparatus can be triggered via a trigger, for example, a light barrier arranged at the conveying apparatus.

Immediately before the initiation by the start signal, the pivoting apparatus and the camera unit are at rest in their respective starting positions. The start signal triggers the pivot movement, whereupon the pivot movement starts and the pivoting apparatus and the camera unit move out of their respective starting positions.

According to one embodiment, the start signal can be triggered by the moving object. For example, the start signal can be triggered by a light barrier passed through by the object, a pushbutton actuated by the object or an inductive sensor acted on by the object. This enables a precise synchronization of the movement of the object on the conveying apparatus, the pivot movement of the camera unit and the recording of the sequence of images. Once the pivoting speed has been adapted to the conveying speed of the conveying apparatus, the camera unit can follow the object and can keep the object continuously in its field of view during the pivoting. The sequence of images produced in so doing consequently shows the object at continuously changing angles of view, whereby the label codes arranged at the object can be captured efficiently. The initiation of the pivot movement by the object, for example by means of a light barrier arranged at the conveying apparatus, thus ensures a precise synchronization between the movement of the object and the capture of the label codes, whereby reliable and consistent results can be provided.

The adaptation of the pivot angle and the pivoting speed can take place automatically, for example on the first putting into operation of the camera system, by entering specific application data via a user interface of the camera unit. The application data can contain information about parameters of the conveying apparatus, such as its conveying speed, and information about the moving objects, such as their maximum width and height. Once the application data have been entered, the camera unit can automatically parameterize the pivoting apparatus without any further manual interaction. The putting into operation and configuration of the camera unit can thus take place very easily and quickly within a few minutes.

According to one embodiment, the drive member can be driven by the motor to perform a translatory movement in order to bring about a pivoting of the camera unit in a pivot plane parallel to the plane of movement of the drive member. The drive member and the motor can in particular interact according to the principle of a reciprocating piston engine. In this respect, the rotational movement of a shaft of the motor is transmitted to a flywheel which is arranged radially about the axis of rotation of the motor and at whose outer periphery the drive member configured as a strut engages. A motor that is in operation drives the flywheel to perform a rotational movement, whereby the drive member connected to the flywheel is excited to perform a periodic translatory movement with alternating forward and backward movements. The drive member is connected to the installation housing at which the camera unit is fixed with its rear side opposite the camera lens. When the motor is in operation, the periodic translatory movement of the drive member causes a pivoting of the camera unit in a pivot plane parallel to the plane of movement of the drive member. This configuration of the connection of the motor, the drive member and the installation housing enables an automatic oscillating movement with a constant direction of rotation of the motor.

According to one embodiment, the drive member can be driven by the motor to perform a rotational movement about the longitudinal axis of said drive member in order to bring about a pivoting of the camera unit in a pivot plane perpendicular to the longitudinal axis of the drive member. In particular, the pivoting apparatus can also be pivoted via a motor that acts directly on a pivot axis of the pivoting apparatus. In this respect, the rotational movement of a shaft of the motor is transmitted directly to an axis of rotation of the installation housing, whereby the installation housing and the camera unit, which is fixed to the installation housing with its rear side opposite the camera lens, are pivoted. Due to the change of the direction of rotation of the shaft of the rotor, rotations of the installation housing to the left and the right can thus be realized. The control of the motor can in this respect take place via a microcontroller or a simple and fixed wiring. In this respect, mechanical switches, optical switches and the use of a microcontroller can help to define the corresponding pivot angles of the pivoting apparatus. This embodiment offers the same functionality as the embodiment described above, but requires less installation space.

According to one embodiment, the pivoting apparatus can be fastened to a construction profile. The construction profile can in particular be an item profile, for example, a 40×40 mm item profile. The pivoting apparatus can be fastened both horizontally and vertically to the construction profile. Thus, the image field that can be captured by the camera unit can be flexibly enlarged either horizontally or vertically. In this respect, the fastening position can be variably selected or displaced. The possibility of fastening the pivoting apparatus both horizontally and vertically on a construction profile enables a great flexibility for the adaptation to different system configurations, which saves time and effort.

In this respect, the pivoting apparatus can in particular be supported by a ball bearing. The use of ball bearings ensures a stable and durable support of the pivoting apparatus, which enables a smooth movement and precise alignment of the camera unit and thus improves the efficiency and reliability of the capture of the label codes.

According to one embodiment, the processor is configured to simultaneously recognize and track at least two objects in an image of the sequence of images, wherein the objects have a minimum mutual distance of at least 50 mm, in particular 30 mm. By means of this so-called tracking, objects can be precisely tracked and sorted without an additional, separate control and monitoring unit being necessary. Tracking enables the simultaneous tracking of a plurality of objects in the field of view of the camera if a minimum distance of 30 mm or 50 mm is guaranteed between the objects. This allows an exact assignment of the label codes to the corresponding objects, whereby a manual reworking or interaction of sorting processes at conveying apparatus is reduced and the sorting efficiency is maximized. Furthermore, a reliable allocation or delivery to the correct recipient or storage region is ensured, for example.

According to one embodiment, the camera system furthermore comprises an encoder that is arranged at the conveying apparatus and that is configured to determine the conveying speed of the conveying apparatus. The determined conveying speed can, for example, be used, to optimize the synchronization of the pivoting and the start of the image capture sequence of an object. Furthermore, in the case of fluctuating conveying speeds of the conveying apparatus, an encoder for speed monitoring may be necessary to enable the simultaneous tracking of a plurality of individual objects in the field of view of the camera unit by means of tracking.

According to one embodiment, the camera unit is configured to change the focus of the camera lens according to the value of the current pivot angle. Since the distance between the camera unit and the object changes continuously during the pivoting, the optimal focus setting of the camera lens also changes continuously. To take this circumstance into account, the camera unit is configured to dynamically change the focus setting of the camera lens. This can, for example, take place via a configuration file that provides the optimal focus settings for different pivot angles. The determination of the respective optimal focus settings for different pivot angles can in particular be determined during a “teach-in” when the camera system is put into operation. Alternatively, it is also possible for the camera unit to have autofocus capabilities that automatically adjust the focus of the camera lens according to the current pivot angle and the thereby changing distance from the object.

According to one embodiment, the camera system has an outer housing in which the camera unit and the pivoting apparatus are arranged and accommodated, wherein the outer housing has at least one transparent viewing window that enables the camera unit to record a sequence of images of the object for each orientation of the camera unit between the starting position and the maximum pivot angle.

According to one embodiment, the viewing window is planar and is tilted with respect to the pivot plane so that the viewing window and the pivot plane are not arranged orthogonally to one another. In particular, the viewing window is tilted relative to the pivot plane such that the viewing window and the pivot plane are not arranged orthogonally to one another in a direction perpendicular to the pivot plane and are arranged orthogonally to one another in a direction parallel to the pivot plane. The inclination of the viewing window helps to deflect light reflected inside the outer housing away from the image sensor. The reflected light can, for example, come from an illumination device that is arranged inside the outer housing and serves to illuminate the object. The angle of inclination is selected such that the occurrence of reflections of the light source of the illumination device in the image field of the camera unit is avoided as far as possible. The angle of inclination consequently depends on parameters such as the distance between the illumination device and the viewing window. For example, the viewing window and the pivot plane can include an angle of inclination in the range between 10 degrees and 30 degrees, and preferably between 15 degrees and 25 degrees, in a direction perpendicular to the pivot plane. To further reduce unwanted reflections, the viewing window can alternatively or additionally have a polarization filter that further reduces the occurrence of reflections.

According to one embodiment, the camera system has a further camera unit that is arranged outside the outer housing, wherein the further camera unit has a static, temporally unchanged image field and is configured to record at least one image of the object moved by the conveying apparatus. The further camera unit has a camera lens and an image sensor. The further camera unit is configured to record a single image of the object or a sequence of images of the object in the form of a stream. The further camera unit can be temporally synchronized with the camera unit so that the data of the camera unit and the further camera have a common time stamp.

The further camera unit enables an automatic capture of all the objects moved by the conveying apparatus, whereby a traceable and transparent operation of the camera system is ensured. The further camera unit can, for example, automatically capture the contents of a pallet before shipping, including all the items and labels, and can thus facilitate the creation of shipping documents. The images of the further camera unit can in this respect serve as visual proof of what has been sent, whereby disputes can be reduced in the event of a possible loss during shipping. Furthermore, in the event of failed identifications of label codes, the images of the further camera unit can provide information on what could have been the cause.

This can take place automatically, whereby unnecessary delays or a subsequent manual processing can be avoided. In addition, the images of the further camera unit provide a view of the transport process in real time, which operators or technicians can use for the remote support of the camera system and for optimizing configuration parameters.

According to one embodiment, the pivoting of the camera unit by the pivoting apparatus and the start of the recording of the image or of the sequence of the images by the further camera unit can be initiated by a start signal, in particular an external start signal. In other words, the pivoting apparatus and the further camera unit can be triggered via a trigger, for example a light barrier. The start signal is triggered as soon as an object moved by the conveying apparatus passes through the light barrier. Immediately before the initiation by the start signal, the pivoting apparatus and the camera unit are at rest in their respective starting positions. The start signal triggers the pivot movement, whereupon the pivot movement starts and the pivoting apparatus and the camera unit move out of their respective starting positions. At the same time, the further camera unit starts the recording of the image or of the sequence of images of the object. The further camera unit is thus temporally synchronized with the camera unit so that the data of the camera unit and the further camera unit have a common time stamp.

According to one embodiment, the camera unit and/or the further camera unit is/are surrounded by a waterproof, windproof and breathable membrane. The membrane can in particular be a Gore-Tex membrane or a membrane composed of a material similar to Gore-Tex. The membrane prevents a condensation at the camera unit in applications in cool or cold environments, such as in a cold-store warehouse or deep-freeze warehouse.

The object is furthermore satisfied by a label recognition apparatus that is configured to identify and decode 1D and/or 2D label codes on at least one object that is moved by a conveying apparatus, in particular a conveyor belt, comprising a camera system mentioned above. The conveying apparatus can be part of the label recognition apparatus.

The statements relating to the camera system according to the invention apply accordingly to the label recognition apparatus according to the invention; this in particular applies with respect to advantages and embodiments. It is also understood that all the features mentioned herein can be combined with one another, unless explicitly stated otherwise.

The invention will be explained only by way of example in the following with reference to the Figures.

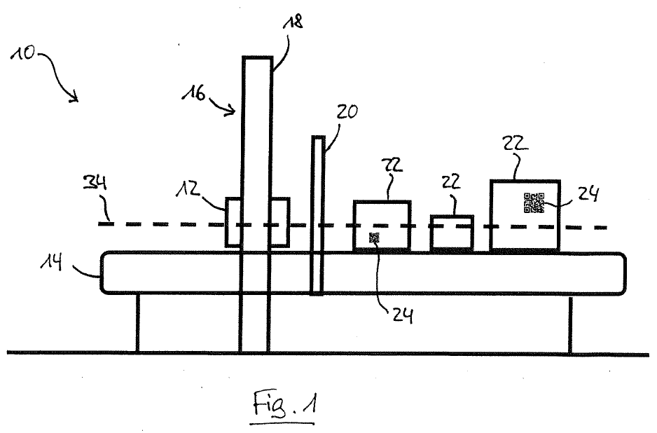

FIG. 1 shows a schematic side view of an embodiment of a label recognition apparatus according to the invention;

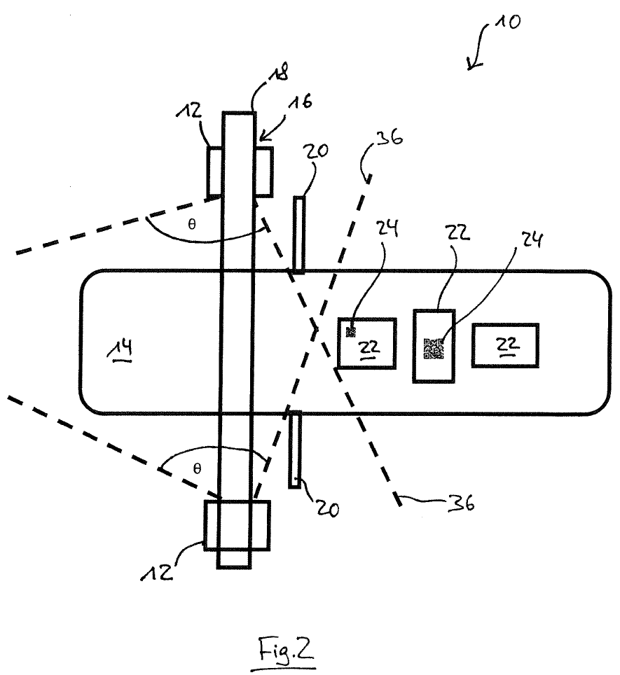

FIG. 2 shows a schematic plan view of the label recognition apparatus of FIG. 1;

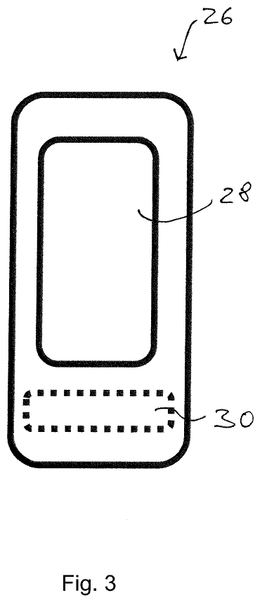

FIG. 3 shows a schematic bottom view of an embodiment of a camera unit of the label recognition apparatus of FIG. 1;

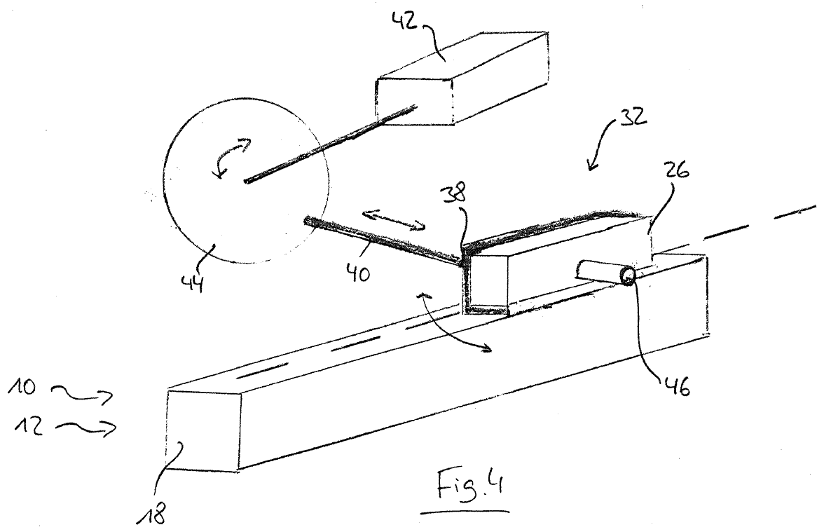

FIG. 4 shows a schematic view of an embodiment of a camera system of the label recognition apparatus of FIG. 1; and

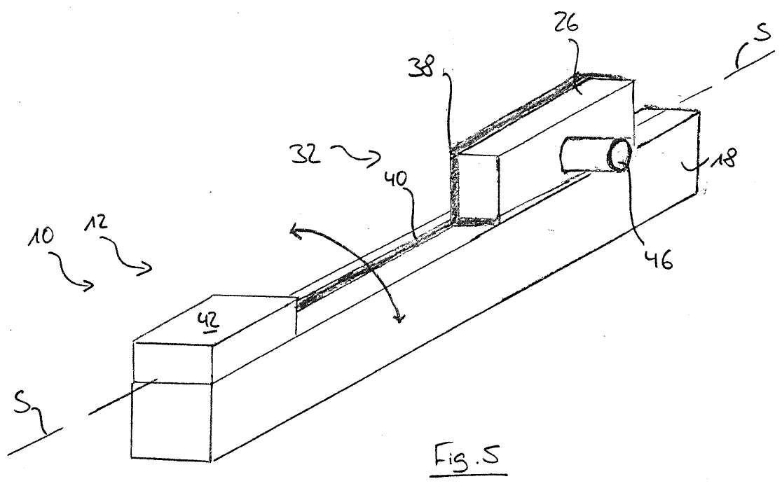

FIG. 5 shows a schematic view of a further embodiment of a camera system of the label recognition apparatus of FIG. 1; and

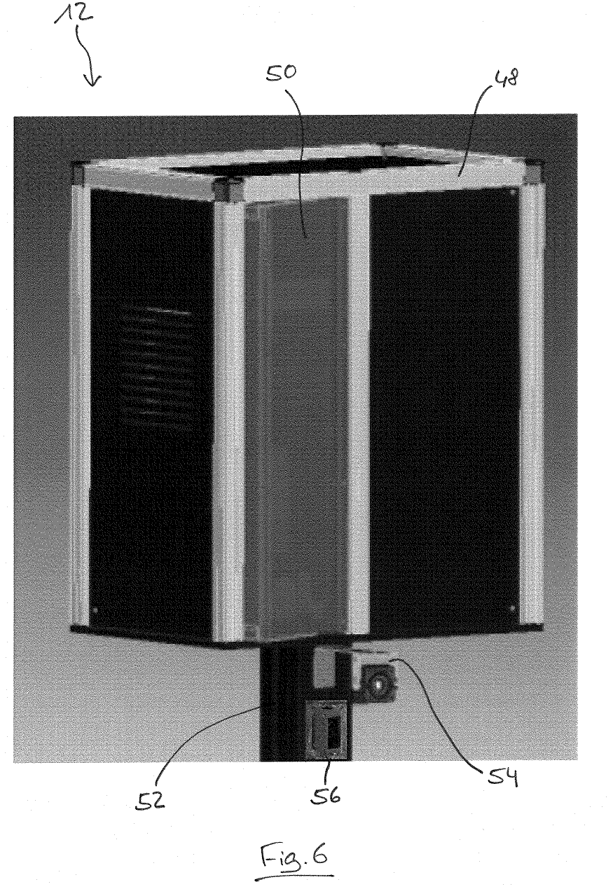

FIG. 6 a schematic view of a further embodiment of a camera system for a label recognition apparatus.

FIGS. 1 and 2 show schematic side and top views of an embodiment of a label recognition apparatus 10 according to the invention. The label recognition apparatus 10 includes a conveying apparatus 14 that is configured as a conveyor belt in the example shown. The label recognition apparatus 14 furthermore has an installation frame 16 that surrounds and spans the conveying apparatus 14 in the shape of a gate. The installation frame 16 can in this respect be formed from interconnected construction profiles 18. The label recognition apparatus 10 furthermore has two camera systems 12 according to the invention that are arranged at both sides of the conveyor belt 14 and that are fastened to the installation frame 16. In this respect, both camera systems 12 have the same design. In the embodiment shown, the label recognition apparatus 10 furthermore has an object detector 20 in the form of a light barrier that is arranged at or close to the installation frame 16 and that is configured to output a detection signal when an object on the conveyor belt 14 passes the light barrier 20.

There is a row of objects 22 on the conveyor belt 14 that are moved or transported in the conveying direction by the conveyor belt 14. The objects 22 can, for example, be packages or complete pallets that can have different heights and widths, as can be seen in FIGS. 1 and 2. At least one label code 24 is furthermore arranged on each of the objects 22, wherein the label codes 24 can be attached at any desired positions and with any desired orientation on the objects 22. The label codes 24 can be 1D and/or 2D label codes, for example, barcodes or QR codes.

FIG. 3 shows a schematic bottom view of an embodiment of a camera unit 26 of the camera systems 12 of FIGS. 1 and 2. The underside shown of the camera unit 12 is oriented in the direction of the conveyor belt 14 in the label recognition apparatus 10 of FIGS. 1 and 2. The camera unit 26 has a camera lens (cf. FIGS. 4 and 5), an image sensor 28 and a processor 30. The camera unit 26 is configured to record a sequence of images of the objects 22 moved on the conveyor belt 14. The processor 30 is configured to process the recorded images and to recognize and identify the label codes 24 arranged on the objects 22.

The camera system 12 according to the invention furthermore has a pivoting apparatus 32 (cf. FIGS. 4 and 5) that is releasably connected to the camera unit 26. The pivoting apparatus 32 is shown and described in more detail in FIGS. 4 and 5. The pivoting apparatus 32 is configured to pivot the camera unit 26 in a pivot plane 34 from a starting position 36 by a settable pivot angle θ, wherein the pivot plane 34 is arranged in a horizontal direction relative to the conveyor belt 14. The starting position 36 in this respect indicates the rest position of the pivoting apparatus 32 and the camera unit 26.

The camera unit 26 is configured to change the focus of the camera lens according to the value of the current pivot angle. Since the distance between the camera unit 26 and the object 22 changes continuously during the pivoting, the optimal focus setting of the camera lens also changes continuously. To take this circumstance into account, the camera unit 26 is configured to dynamically change the focus setting of the camera lens. This can, for example, take place via a configuration file that provides the optimal focus settings for different pivot angles. The determination of the respective optimal focus settings for different pivot angles can in particular be determined during a “teach-in” when putting the camera system 12 into operation. Alternatively, it is also possible that the camera unit 26 has autofocus capabilities that automatically adjust the focus of the camera lens according to the current pivot angle and the thereby changing distance from the object 22.

Due to the pivoting, the respective object 22 moved on the conveyor belt 14 can be captured by the camera unit 26 and its image sensor 28 in the sequence of images at different capture angles, wherein the different capture angles result from the pivoting of the image field of the camera unit 26 by the pivoting apparatus 32. A recording of images of the respective object 22 and the capturing of the label codes 24 arranged thereon at different capture angles of the camera unit 26 are thus achieved by the camera unit 26 itself being pivoted. The recording of images of the respective object 22 at different capture angles ensures that a label code 24 arranged on the object 22 is captured in the images regardless of its position and orientation on the object 22 and also regardless of the size and orientation of the object 22. The images of the object 22 are transmitted to the processor 30 that processes them and scans the images for 1D and/or 2D label codes arranged on the object 22, said processor recognizing and reliably identifying said 1D and/or 2D label codes.

The pivoting of the camera unit 26 by the pivoting apparatus 32 is triggered by a detection signal that is transmitted to the camera system 22 by the object detector 20 on the detection of an object 22 on the conveyor belt 14. Since the pivoting speed of the pivot movement can be adapted to the conveying speed, a precise synchronization of the movement of the object 22 on the conveyor belt 14, the pivot movement of the camera unit 26 and the recording of the sequence of images can hereby be achieved. Due to the synchronization, the camera unit 26 can follow the object 22 and can continuously keep the object in its field of view during the pivoting.

Consequently, the sequence of images produced in so doing shows the object 22 at continuously changing angles of view, whereby the label codes 24 arranged at the object 22 can be captured efficiently and reliably.

Two embodiments of a camera system 12 and in particular their pivot apparatus 32 are shown in schematic views in FIGS. 4 and 5. The pivoting apparatus 32 of both embodiments has an installation housing 38, a drive member 40 and an electric motor 42. The camera unit 26 is releasably fixed to the respective installation housing 38 by means of fastening elements 42. The drive member 40 is connected to the installation housing 38 and can be driven by the electric motor 42 to bring about a pivoting of the installation housing 38 and the camera unit 26. The pivoting of the camera unit 26 is thus effected via a pivoting of the respective installation housing 38, wherein the drive member 40 is in an operative connection with the installation housing 38. The drive member 40 thus pivots the installation housing 38 in the pivot plane 34 when driven by the electric motor. The pivot axis S extending orthogonally to the pivot plane 34 is arranged outside the camera unit 26 and extends along a longitudinal axis of the installation housing 38 in the embodiments of FIGS. 4 and 5.

In the embodiment of FIG. 4, the drive member 40 can be driven by the electric motor 42 to perform a translatory movement in order to bring about a pivoting of the camera unit 26 in a pivot plane 34 parallel to the plane of movement of the drive member 40. In this embodiment, the drive member 40 and the electric motor 42 work together according to the principle of a reciprocating piston motor. In this respect, the rotational movement of a shaft, not shown, of the electric motor is transmitted to a flywheel 44 which is arranged radially about the axis of rotation of the electric motor and at whose outer periphery the drive member 40 configured as a strut engages.

An electric motor that is in operation drives the flywheel 44 to perform a rotational movement, whereby the drive member 40 connected to the flywheel 44 is excited to perform a periodic translatory movement with alternating forward and backward movements. The drive member 40 is connected to the installation housing 38 to which the camera unit 26 is fixed with its rear side opposite the camera lens 46. When the electric motor is in operation, the periodic translatory movement of the drive member 40 causes a pivoting of the camera unit 26 in a pivot plane 34 parallel to the plane of movement of the drive member 40. This configuration of the connection of the electric motor 42, the drive member 40 and the installation housing 38 enables an automatic oscillating movement with a constant direction of rotation of the electric motor. The camera unit 26 is thus returned to the starting position 36 after a pivoting about the pivot angle θ has taken place.

In the embodiment of FIG. 5, the drive member 40 can be driven by the electric motor 42 to perform a rotational movement about the longitudinal axis of said drive member in order to bring about a pivoting of the camera unit 26 in a pivot plane 34 perpendicular to the longitudinal axis of the drive member 40. In this respect, the rotational movement of a shaft of the electric motor 42 is transmitted directly to an axis of rotation of the installation housing 38, whereby the installation housing 26 and the camera unit 26, which is fixed to the installation housing 38 with its rear side opposite the camera lens 46, are pivoted. Due to a change in the direction of rotation of the shaft of the electric motor 42, rotations of the installation housing 38 to the left and the right can thus be realized. The control of the electric motor 44 can take place via a microcontroller or wiring. In this respect, mechanical switches, optical switches and the use of a microcontroller can help to define the corresponding pivot angles θ of the pivoting apparatus 32. This embodiment offers the same functionality as the embodiment in FIG. 4, but requires less installation space.

FIG. 6 shows a schematic view of a further embodiment of a camera system 12 for a label recognition apparatus 10. The camera system 12 is arranged to the side of a conveying apparatus, not shown. The camera system 12 has an outer housing 48 in which a camera unit and a pivoting apparatus are arranged and accommodated. The outer housing 48 has at least one transparent viewing window 50 that enables the camera unit to record a sequence of images of an object moved by the conveying apparatus for each orientation between the starting position and the maximum pivot angle.

The outer housing 48 is fastened to a construction profile 52. The construction profile 52 can have a fastening apparatus, not shown, for example, a fastening plate that makes it possible to fix the outer housing 48 in a vibration-proof manner in a working environment. The outer housing 48 is rotatably supported at the construction profile 52 to be able to align and fix the camera system 12 at different angles to a conveying apparatus.

The pivoting apparatus 32 is configured to pivot the camera unit from a starting position about a pivot angle in a pivot plane arranged parallel to the construction profile 52. The viewing window 50 is planar and tilted relative to the pivot plane so that the viewing window 50 and the pivot plane are not arranged orthogonally to one another. In particular, the viewing window 50 is tilted relative to the pivot plane 52 such that the viewing window 50 and the pivot plane are not arranged orthogonally to one another in a direction perpendicular to the pivot plane and are arranged orthogonally to one another in a direction parallel to the pivot plane. The inclination of the viewing window 50 helps to deflect light reflected inside the outer housing 48 away from the image sensor. For example, the viewing window 52 and the pivot plane can include an angle of inclination in a direction perpendicular to the pivot plane in the range between 10 degrees and 30 degrees and preferably between 15 degrees and 25 degrees. To further reduce unwanted reflections, the viewing window 50 can have a polarization filter that further reduces the occurrence of reflections.

The camera system 12 has a further camera unit 54 that is arranged outside the outer housing 48 at the construction profile 52. The further camera unit 54 has a static, temporally unchanged image field and is configured to record at least one image of the object moved by the conveying apparatus. In this respect, the further camera unit 54 can be configured to record a single image of the object or a sequence of images of the object in the form of a stream.

The vertical pivoting of the camera unit by the pivoting apparatus and the start of the recording of the image or of the sequence of the images by the further camera unit 54 is initiated by an external start signal. For this purpose, an object detector in the form of a light barrier 56 is arranged at the construction profile 52. The start signal is triggered as soon as an object moved by the conveying apparatus passes through the light barrier 56.

Immediately before the initiation by the start signal, the pivoting apparatus and the camera unit are at rest in their respective starting positions. The start signal triggers the pivot movement, whereupon the pivot movement starts and the pivoting apparatus and the camera unit move out of their respective starting positions. At the same time, the further camera unit 54 starts the recording of the image or of the sequence of images of the object. The further camera unit 54 is thus temporally synchronized with the camera unit so that the data of the camera unit 26 and the further camera unit 54 have a common time stamp.

Camera systems 12 comprising pivot apparatus 32 of the embodiments shown enable the complete capture of objects 22 on a conveyor belt 14, regardless of their height or width, and the complete and reliable capture of label codes 14 arranged at the objects 22.

### REFERENCE NUMERALS

10 label recognition apparatus
12 camera system
14 conveying apparatus
16 installation frame
18 construction profile
20 object detector
22 object
24 label code
26 camera unit
28 image sensor
30 processor
32 pivoting apparatus
34 pivot plane
36 starting position
38 installation housing
40 drive member
42 electric motor
44 flywheel
46 camera lens
48 outer housing
50 viewing window
52 construction profile
54 further camera unit
56 object detector
pivot angle θ
pivot axis S

1-15. (canceled)

16. A camera system for a label recognition apparatus, wherein the camera system is configured to recognize 1D and/or 2D label codes on at least one object that is moved by a conveying apparatus,
wherein the camera system has a camera unit having a camera lens and an image sensor as well as a processor,
wherein the camera unit is configured to record a sequence of images of the object, wherein the processor is configured to process the images and to recognize 1D and/or 2D label codes arranged on the object,
wherein the camera system has a pivoting apparatus that is connected to the camera unit and that is configured to pivot the camera unit in at least one pivot plane from a starting position about a pivot angle.

17. The camera system according to claim 16, wherein a pivot axis associated with the pivot plane is arranged outside the camera unit.

18. The camera system according to claim 16, wherein the pivoting apparatus has an installation housing, a drive member and a motor, and wherein the camera unit is fixed to the installation housing, the drive member is connected to the installation housing and the drive member can be driven by the motor to bring about a pivoting of the installation housing and the camera unit.

19. The camera system according to claim 16, wherein the pivoting apparatus is configured to return the camera unit to the starting position after a pivoting about the pivot angle has taken place.

20. The camera system according to claim 16, wherein the pivot angle can be predefined or is predefined.

21. The camera system according to claim 16, wherein the pivoting apparatus is configured to pivot the camera unit in the pivot plane at a predefined or predefinable pivoting speed.

22. The camera system according to claim 16, wherein a maximum pivot angle is 120 degrees.

23. The camera system according to claim 16, wherein the pivoting of the camera unit by the pivoting apparatus can be initiated by a start signal.

24. The camera system according to claim 23, wherein the start signal can be triggered by the moving object.

25. The camera system according to claim 16, wherein the drive member can be driven by the motor to perform a translatory movement in order to bring about a pivoting of the camera unit in a pivot plane parallel to the plane of movement of the drive member.

26. The camera system according to claim 16, wherein the drive member can be driven by the motor to perform a rotational movement about the longitudinal axis of said drive member in order to bring about a pivoting of the camera unit in a pivot plane perpendicular to the longitudinal axis of the drive member.

27. The camera system according to claim 16, wherein the pivoting apparatus can be fastened to a construction profile.

28. The camera system according to claim 16, wherein the processor is configured to simultaneously recognize and track at least two objects in an image of the sequence of images, wherein the objects have a minimum mutual distance of at least 50 mm.

29. The camera system according to claim 16, furthermore comprising an encoder that is arranged at the conveying apparatus and that is configured to determine the conveying speed of the conveying apparatus.

30. A label recognition apparatus that is configured to identify and decode 1D and/or 2D label codes on at least one object that is moved by a conveying apparatus, said label recognition apparatus comprising a camera system according to claim 16.

31. The camera system according to claim 16, wherein the pivoting apparatus is releasably connected to the camera unit.

32. The camera system according to claim 18, wherein the motor is an electric motor.

33. The camera system according to claim 18, wherein the camera unit is releasably fixed to the installation housing.

34. The camera system according to claim 21, wherein the pivoting speed is adapted to a conveying speed of the conveying apparatus.

35. The camera system according to claim 16, wherein a maximum pivot angle is 150 degrees.

36. The camera system according to claim 16, wherein a maximum pivot angle is 180 degrees.

37. The camera system according to claim 23, wherein the start signal is an external start signal.

38. The camera system according to claim 16, wherein the processor is configured to simultaneously recognize and track at least two objects in an image of the sequence of images, wherein the objects have a minimum mutual distance of at least 30 mm.

39. The label recognition apparatus according to claim 30, wherein the conveying
apparatus is a conveyor belt.
